(19) United States
(12) Patent Application Publication
(10) Pub. No.: US 2007/0103335 A1
(43) Pub. Date: May 10, 2007

(54) Automatic detection of unusual consumption by a utility meter

(76) Inventors: Aaron J. Fitzgerald, Medford, MN (US); Kenneth C. Rigdon, Mapleton, MN (US); Kristin R. Stroda, Waseca, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/584,351

(22) Filed: Oct. 20, 2006

Related U.S. Application Data
(60) Provisional application No. 60/728,643, filed on Oct. 20, 2005.

(51) Int. Cl. G08C 15/06

(52) U.S. Cl. 340/870.02

(57) ABSTRACT

A utility meter endpoint measures consumption of a commodity such as water, gas, or electricity, includes a configurable function for detecting the presence of an abnormality in consumption such as leaks, tampering, short-circuits or other malfunctions, or unauthorized bypassing of the meter, and the like. The endpoint can take multiple samples according to a configurable time schedule, and test the usage pattern against programmable criteria that reflect certain types of unusual activity or other problems. If the criteria are satisfied, the endpoint can report the occurrence of the unusual event to the AMR system during its usual communications cycle or by initiating a special, unscheduled communication to signal an alarm condition.

### RELATED APPLICATIONS

This application claims priority to U.S. provisional application 60/728,643, filed Oct. 20, 2005, the disclosure of which is incorporated by reference herein in its entirety.

### FIELD OF THE INVENTION

The invention relates generally to metering of utility consumption, and more particularly, to detecting unusual consumption patterns.

### BACKGROUND OF THE INVENTION

Automatic meter reading (AMR) systems are generally known in the art. Utility companies, for example, use AMR systems to read and monitor customer meters remotely, typically using radio frequency (RF) communication. AMR systems are favored by utility companies and others who use them because they increase the efficiency and accuracy of collecting readings and managing customer billing. For example, utilizing an AMR system for the monthly reading of residential gas, electric, or water meters eliminates the need for a utility employee to physically enter each residence or business where a meter is located to transcribe a meter reading by hand.

There are several different ways in which current AMR systems are configured. In a fixed network, endpoint devices at meter locations communicate with readers that collect readings and data using RF communication. There may be multiple fixed intermediate readers, or relays, located throughout a larger geographic area on utility poles, for example, with each endpoint device associated with a particular reader and each reader in turn communicating with a central system. Other fixed systems utilize only one central reader with which all endpoint devices communicate. In a mobile environment, a handheld unit or otherwise mobile reader with RF communication capabilities is used to collect data from endpoint devices as the mobile reader is moved from place to place.

AMR systems generally include one-way, one-and-a-half-way, or two-way communications capabilities. In a one-way system, an endpoint device periodically turns on, or “bubbles up,” to send data to a receiver. One-and-a-half-way AMR systems include receivers that send wake-up signals to endpoint devices that in turn respond with readings. Two-way systems enable command and control between the endpoint device and a receiver/transmitter as well as to data transmission by the endpoint device.

In addition to reporting consumption information, there is a need for endpoint devices to indicate alerts to the utility provider when unusual or suspicious activity is detected. Tamper and malfunction detection systems incorporated in utility meters are generally known in the art. These include mechanical, electromechanical, optical, and electronic systems, such as those described in U.S. Pat. Nos. 3,893,586; 4,588,949; 4,665,359; 4,811,600; 5,025,470; 5,086,292; 5,113,130; 5,148,101; 5,293,115; 5,422,565; 5,473,322; 6,098,456; and 6,236,197.

Although the aforementioned event detection systems can indicate unusual conditions occurring with the meter or endpoint, these systems are not designed to recognize unusual consumption patterns that are indicative of problems or misuse such as leaks or bypassing of the meter by the customer when the meter or endpoint device itself has not been directly tampered with.

Analysis of metered data collected at the central station can indicate long-term average usage trends, but the collected consumption data typically is not sampled and collected sufficiently frequently to enable extraction of the necessary short-term patterns such as abrupt but temporary changes in consumption. For example, conventionally-collected meter readings do not distinguish between consumption patterns during the day versus during the night. Increasing the meter reading frequency is often impractical due to limitations in the AMR system communications channel capacity. Furthermore, because endpoint devices are typically battery-powered and because of traffic limits on the number and frequency of transmissions, it is not desirable to significantly increase the number of radio transmission of information.

### SUMMARY OF THE INVENTION

One aspect of the invention is directed to a utility meter endpoint that measures consumption of a commodity such as water, gas, or electricity, includes a configurable function for detecting the presence of an abnormality in consumption. Such abnormalities include, but are not limited to, leaks, tampering, short-circuits or other malfunctions, or unauthorized bypassing of the meter, and the like. Preferably, in response to detecting an abnormality, the endpoint device provides an indication to that effect via an automatic meter reading (AMR) system to a reader or data receiving station.

Instead of having to transmit the meter readings more frequently to detect usage patterns or short-term changes in consumption, a utility meter endpoint according to one embodiment of the invention takes multiple samples according to a configurable time schedule, and tests the usage pattern against programmable criteria that reflect certain types of unusual activity or other problems. If the criteria are satisfied, the endpoint can report to the AMR system during its usual communications cycle that it has detected an unusual event. Alternatively, the endpoint can initiate a special, unscheduled communication to signal an alarm condition.

In one embodiment, utility providers can define the programmable criteria based on a set of parameters such as: one or more consumption rate thresholds, number of occurrences of threshold events in a defined time period, duration of sampling of consumption, and frequency of sampling. Different types of meters and installations can be associated with corresponding default parameter settings. For example, single family dwellings, multi-family dwellings, commercial sites, light industrial, and heavy industrial installations can each have a different set of parameter settings.

In a related embodiment, the endpoint device can be programmed to automatically learn each customer's established usage pattern, and identify suspicious deviations from the established pattern.

### BRIEF DESCRIPTION OF THE DRAWINGS

The invention may be more completely understood in consideration of the following detailed description of various embodiments of the invention in connection with the accompanying drawings, in which:

FIG. 1 is an exemplary diagram of a coverage cell of a fixed AMR system in accordance with an embodiment of the invention.

FIG. 2 is a diagram illustrating an example embodiment of a utility meter endpoint adapted to communicate wirelessly with an AMR system.

FIG. 3 is a flow diagram illustrating one method of detecting an unusual consumption pattern by an endpoint according to one aspect of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

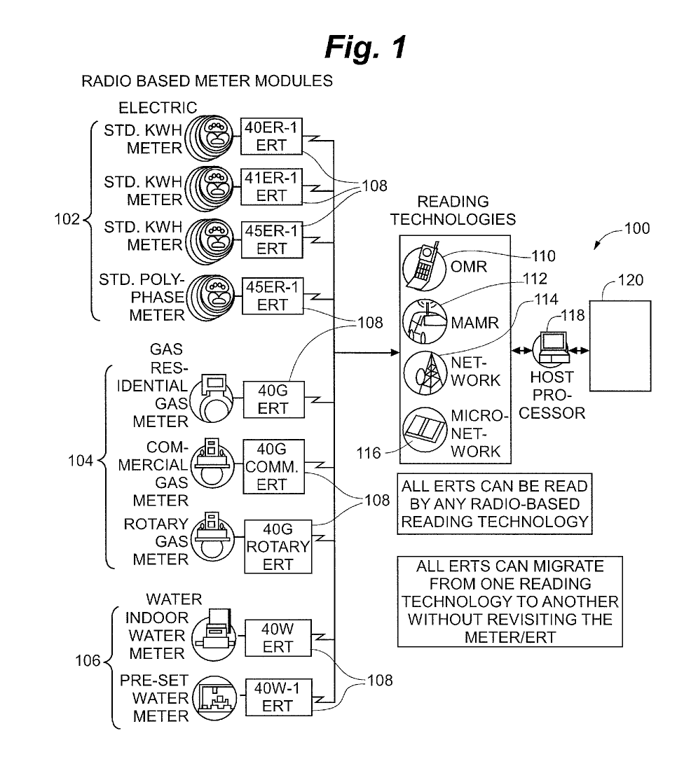

Endpoints and AMR communication modes AMR system 100, as depicted in FIG. 1, that utilizes the invention includes at least one utility measurement device including, but not limited to, electric meters 102, gas meters 104 and water meters 106. Each of the meters may be either electrically or battery powered. The system further includes at least one endpoint 108, wherein each corresponds and interfaces to a meter. Each of the endpoints 108 preferably incorporates a radio frequency (RF) device, e.g., the Itron®, Inc. ERT as described in detail, for example, in U.S. Pat. Nos. 5,056,107; 6,262,685; and 6,934,316, the disclosures of which are hereby incorporated by reference. The system additionally includes one or more readers that may be fixed or mobile, FIG. 1 depicts: (1) a mobile hand-held reader 110, such as that used in the Itron Off-site meter reading system; (2) a mobile vehicle-equipped reader 112, such as that used in the Itron Mobile AMR system; (3) a fixed radio communication network 114, such as the Itron Fixed Network AMR system that utilizes the additional components of cell central control units (CCUs) and network control nodes (NCNs); and (4) a fixed micro-network system, such as the Itron MicroNetwork™ AMR system that utilizes both radio communication through concentrators and telephone communications through PSTN. The disclosure of the various patents and technical publications describing these systems are hereby incorporated by reference. Of course other types of endpoint devices, readers and AMR networks may be used without departing from the spirit or scope of the invention. Further included in AMR system 100 is a head-end, host processor 118 that incorporates software that manages the collection of metering data and facilitates the transfer of that data to a utility or supplier billing system 120.

Data collected by the endpoints 108 can be read via the AMR system by mobile readers 110, 112, or fixed radio communication network 114. Alternatively, data can be read and re-transmitted by the AMR system via an intermediate transmitter/receiver that extends the range of communication between a reader and endpoints 108. Regardless of how the endpoint data is read, in one embodiment a reader may include a transmitter, a receiver, an input component and a data storage component.

In AMR system 100, endpoints 108 can support one-way meter reading, 1.5-way meter reading, or two-way meter reading systems. In a one-way meter reading system, the reader listens to messages sent asynchronously from each endpoint. In such a system, endpoints do not need to receive any information from the reader. In a two-way meter reading system, endpoints listen for, and respond to prompting signals issued by the reader. Prompting signaling may include requests for utility meter consumption data, information about the endpoint's operational status or configuration settings, information about events that might have occurred (such as any outages), instructions to modify specified operating parameters, or the like. Therefore, a two-way meter reading system facilitates the AMR system reader's communicating with and optionally commanding the endpoint, while also facilitating the endpoint's responding to the reader's communications and commands. A 1.5-way meter reading system facilitates prompting endpoints to request data transmission by the endpoints, but avoids the additional complexity of command and control communications of two-way systems. In a 1.5-way system, the reader sends prompting signals to endpoints, which, in turn, listen for, and respond to the prompting signals by simply transmitting their collected data.

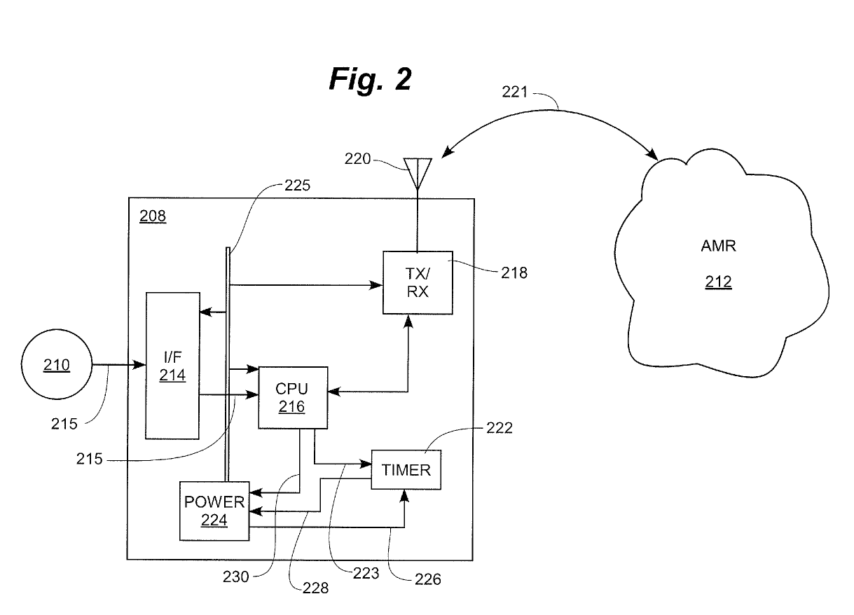

FIG. 2 illustrates one exemplary embodiment of a utility meter endpoint 208. Endpoint 208 interfaces with a utility meter 210, receives consumption, utility meter status, history, and other such relevant data from utility meter 210, and communicates the data to AMR system 212. Endpoint 208 includes an interface system 214, which operatively couples to utility meter 210 via coupling 215. In one embodiment, coupling 215 includes electrical and mechanical components for making a physical and electrical connection between utility meter 210 and endpoint 208. For example, coupling 215 can include electrical connectors and conductors that carry electrical signals from utility meter 210 to interface hardware in interface system 208 that converts the electrical signals into a digital representation that is readable by a microprocessor or microcontroller 216. Interface system 214 is, itself, interfaced with microprocessor 216 via interface 215. In one embodiment, interface 215 includes a portion of a data bus and of an address bus. Alternatively, interface 215 may comprise a serial communication link.

Microprocessor 216 is a controller that oversees operation of endpoint 208. In one embodiment, microprocessor 216 includes a microprocessor system that has memory, instruction processing, and input/output circuits. Microprocessor 216 interfaces with radio transceiver 218 via interface 217. In one embodiment, interface 217 includes a portion of a data bus and of an address bus, which is coupled to an antenna 220. Alternatively, interface 217 may comprise a serial communication channel. In operation, interface hardware 214 forwards and converts utility meter data to microprocessor 216. Microprocessor 216 processes, and stores the data at least temporarily, and instructs transceiver 218 to communicate the data to AMR system 212 at appropriate or preprogrammed/predefined times.

In one embodiment, endpoint 208 operates in a low-power standby mode during a majority (>50%) of the time. While in the standby mode, interface system 214, microprocessor 216, and transceiver 218 are effectively shut down so that they consume at most a negligible amount of power. Timer 222 operates to periodically wake up the shut-down systems so that they enter into an active operating mode. In one embodiment, timer 222 is an independent circuit that is interfaced with microprocessor 216. In another embodiment, timer 222 is implemented as a watchdog timer in a microcontroller that is a part of microprocessor 216. In either embodiment, one feature of timer 222 is that timer 222 consumes relatively little energy for operating. Also, upon expiration of a time duration set into timer 222, timer 222 provides a signal that initiates bringing online the systems that are in standby mode. In a related embodiment, the settable time duration is set in timer 222 by microprocessor 216 via setup signal 223. For example, setup signal 223 can be carried via a data bus or other communication channel.

According to one example embodiment, endpoint 208 includes a power supply 224. In this embodiment, power supply 224 includes one or more batteries. Power supply 224 provides conditioned power to interface system 214, microprocessor 216, and transceiver 218 via switchable power bus 225. Power supply 224 provides conditioned power to timer 222 via power line 226. Timer 222 provides a control signal 228 to power supply 224 that causes power supply 224 to apply power to power bus 225. Microprocessor 216 provides a control signal 230 to power supply 224 that causes power supply 224 to remove power from power bus 225. In operation, beginning in a standby mode, timer 222 has been configured with a set time duration by microprocessor 216 via setup signal 223. Timer 222 monitors the passing of the time duration and, at the expiration of the time duration, timer 222 provides a signal to power supply 224 to energize power bus 225. Once power is applied via power bus 225 to microprocessor 216, interface system 214, and transceiver 218, microprocessor 216 begins executing a program instructions or code that gathers data from utility meter 210 via interface system 214, and momentarily activates transceiver 218. Once the program is complete, microprocessor 216 sets a time duration into timer 222 and initiates timing, and generates control signal 230 to power down the systems that have been powered via power bus 225.

The momentary operation cycle described above is one example of endpoint activity in response to a bubble-up event. A bubble-up event is herein defined as a condition to which an endpoint responds by exiting a low-power standby operating mode or state, and enters a more active operating mode or state for the purpose of gathering data and/or engaging in data communications. One example of a bubble-up event is the passage of a predefined period of time since the previous bubble-up event. Another example of a bubble-up event is an occurrence of a predefined date and time at which a communication cycle has been scheduled to take place. In one example embodiment of endpoint 208, in response to a bubble-up event, transceiver 218 operates in a one-way communications mode, in which it simply transmits the utility meter data via RF communication 221. To support this example one-way communication, the reader operates continuously in a mode receptive to transmissions by endpoints. Depending on its programmed operating mode, endpoint 208 can respond to a bubble-up event by gathering and processing meter data for later transmission in response to a future bubble-up event.

Two-way and 1.5-way endpoints can also communicatively respond to bubble-up events by entering into a temporary receptive operating mode for a predefined duration of time. For example, in one embodiment, if transceiver 218 detects any incoming communications via the AMR system during the time duration, transceiver 218 signals microprocessor 216. Microprocessor 216 then determines whether to respond to the received signal. In one embodiment of a two-way endpoint, microprocessor 216 is programmed to listen for further instructions from AMR system 212 when microprocessor 216 determines that communications have been directed at endpoint 208. The further instructions could request particular information such as utility meter consumption data transmission from endpoint 208, in which case endpoint 208 will transmit such data. Alternatively, the further instructions could request a configuration change in endpoint 208, in which case microprocessor 216 will institute the requested change if such a change is permitted. In this example embodiment, AMR system 212 can communicate any number of instructions, such as configuration changes, requests for data transmission, or the like, to endpoint 208. In turn, endpoint 208 responds to any such received instructions according to its operating program.

In one embodiment of a 1.5-way endpoint, microprocessor 216 is programmed to cause the endpoint 208 to transmit a predefined set of data, such as, for example, utility consumption data, during a specified time slot in response to a received signal determined to be directed to the endpoint. In this manner, the example 1.5-way endpoint avoids the extra processing, receiving, and associated energy consumption needed to support a two-way communication protocol.

In one embodiment, endpoint 208 can voluntarily initiate transmission of additional information that was not requested or expected by AMR system 212. For example, endpoint 208 can transmit alarm information such as in response to a detected tampering event or to a suspicious change in utility consumption. Such information can be transmitted during a scheduled bubble-up event, or spontaneously, depending on the urgency or priority of the information.

Detection of Unusual Consumption Activity

According to one aspect of the invention, the endpoint is programmed to operate during two types of bubble-up events: data gathering bubble-up events, and data transmission bubble-up events. In data gathering bubble-up events, endpoint 208 powers up to read the utility meter, store the consumption and other information, and conduct further processing of the gathered information. The endpoint does not normally transmit data to the AMR system during this type of bubble-up event. The data processing includes analysis of usage patterns to detect tampering, leaks, malfunctions, suspicious activity, or other abnormalities. Data gathering bubble-up events occur at a frequency that corresponds to the time instances when the meter data is to be sampled. Between bubble-ups, endpoint 208 can remain in a low-power standby state.

In data transmission bubble-up events, endpoint 208 can perform all of the functions normally performed in data gathering bubble-up events. Additionally, endpoint conducts communications with the AMR system. A data transmission bubble-up event can occur at a scheduled or adjustable interval, for example, to optimize communication reliability in the AMR system, and battery life in endpoint 208. Additionally, data transmission bubble-up events can occur based upon the happening of an event, such as a detection of unusual consumption activity by endpoint 208.

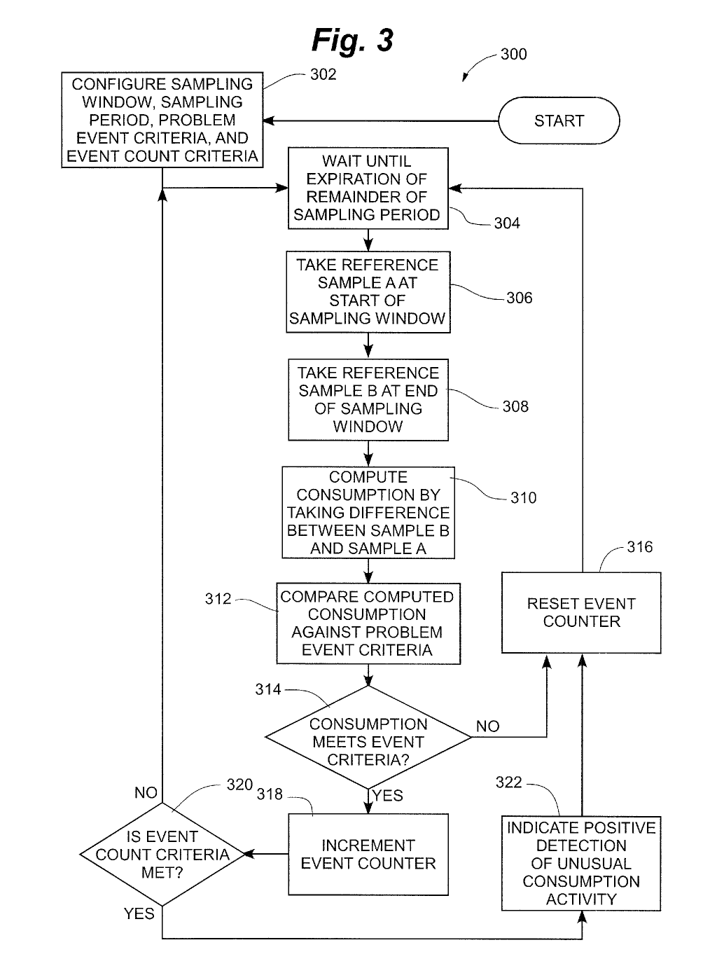

FIG. 3 is a flow diagram illustrating an exemplary routine 300 for detecting unusual consumption events. In one embodiment, steps of routine 300 are performed during data gathering and data transmission bubble-up events. In another embodiment, only a portion of a particular step of routine 300 is performed, depending on the nature of the operations in the step.

Routine 300 is based on taking samples of utility meter consumption information, determining the amount of consumption occurring during pre-defined intervals, comparing the determined consumption amounts against criteria representing unusual activity, and, if the criteria are satisfied, identifying that an unusual event has been detected. In a preferred embodiment, the sampling intervals and decision criteria are configurable. For example, these parameters can be configured at the factory, or on-site by an installer. In 1.5-way and 2-way AMR systems, the parameters can be remotely configured via AMR communications. In one approach, endpoint 208 conducts heuristic analysis according to a self-learning program to set the configurable parameters based on the history of utility consumption at the specific utility meter installation. In a related embodiment, the self-learning program has configurable parameters, which permits the utility provider to dynamically re-define how endpoint 208 learns.

According to routine 300, at 302, endpoint 208 self-configures, or receives configuration information to define a sampling window, sampling period, problem event criteria, and event count criteria. Table 1 below summarizes these exemplary parameters.

TABLE 1
Exemplary Configurable Parameters

| Parameter | Definition | Example |
|---|---|---|
| Sampling window | Time interval for which an | 10 minutes |
| | amount of consumption is | |
| | computed | |
| Sampling period | Frequency of occurrence of the | 1 hour |
| | sampling window | |
| Problem event criteria | An unusual consumption amount | A high or low threshold |
| | (high or low) for a given sampling | such as: |
| | window which, if experienced to a | 50 gallons per |
| | sufficient extent (as determined | sampling window; |
| | by the event count criteria), is | <1 CFM per sampling |
| | cause for indicating a presence of | window |
| | unusual consumption activity | Outside the range of 5-25 kWh |
| | | per sampling |
| | | window between 1:00 |
| | | A.M. and 5:30 A.M. |
| Event count criteria | Number of occurrences | 24 consecutive |
| | (consecutively or per unit time) of | occurrences |
| | unusual consumption amounts | At least 20 |
| | needed to trigger indication of | occurrences out of the |
| | unusual consumption activity | last 24 sampling |
| | | periods |
| | | 50 occurrences |
| | | between 8:00 A.M. |
| | | and 8:00 P.M. over the |
| | | last calendar month |

At step 304, endpoint 208 pauses until the end of the current sampling period, i.e., until the start of the next sampling period. On startup of routine 300, the start of the next sampling period can be immediate. In one embodiment, step 304 is executed by scheduling the next bubble-up event to coincide with the start of the next sampling period, and entering the low-power standby mode.

At 306, at the beginning of the sampling window, endpoint 208 takes a first meter reading, and stores it. Endpoint 208 can then schedule the next bubble-up event to occur at the time corresponding to the end of the sampling window. At that time, at 308, endpoint 208 takes a second, reference meter reading. At 310, the amount of supplied commodity consumed during the sampling window is computed, such as by taking the difference between the first and second meter readings.

At 312, endpoint 208 compares the computed difference against the problem event criteria. The comparison can be as simple as subtracting a low threshold from the computed consumption during the sampling window, for example. If, as indicated at 314, the problem event criteria is not met, the event counter is reset at 316, and the routine loops back to step 304. If, on the other hand, the problem criteria are met by the measured consumption during the sampling window, the event occurrence is recorded. In one embodiment, the recording consists of simply incrementing an event counter, as indicated at 318. Alternatively, actual reading values and/or computed or measured information may be recorded.

Next, at 320, endpoint 208 tests whether the records of the event occurrences meet the previously-established event count criteria. If the event count criteria are not met, the routine loops back to 304 to continue gathering sampled data. If the event count criteria have been met, the routine indicates that a positive detection of unusual consumption activity has occurred. In one embodiment, based on the severity of the detected unusual consumption event, endpoint 208 may wait until the next communication time to issue the indication to the AMR system, or may issue an alarm immediately. The routine proceeds to either store a record of the positive detection, or to clear the detection flag, and loop back to 316.

The present invention may be embodied in other specific forms without departing from the spirit of the essential attributes thereof, therefore, the illustrated embodiments should be considered in all respects as illustrative and not restrictive.

What is claimed is:

1. In an automatic meter-reading system comprising an endpoint communicatively coupled to a utility meter, a method of operating the endpoint, the method comprising:
a) taking and storing in memory a first reading from the utility meter at a start of a sampling window;
b) taking a second reading from the utility meter at an end of the sampling window;
c) determining a utility consumption during the sampling window from the first and second readings to produce a determined utility consumption;
d) comparing the determined utility consumption to a problem-event criterion and, in response,
e) saving in memory the determined utility consumption as an occurrence if the determined utility consumption meets the problem-event criterion;
f) repeating (a)-(e);
g) comparing to an event-count criterion a number of consecutive times the determined utility consumption has met the problem-event criterion; and
h) transmitting an RF signal indicating a positive detection if the number of consecutive times the determined utility consumption has met the problem-event criterion equals or exceeds the event-count criterion.

2. The method of claim 1, further comprising the step of configuring the sampling window, the sampling period, the problem-event criterion, or the event-count criterion by the endpoint using self-learning software.

3. The method of claim 1, further comprising the step of configuring the sampling window, the sampling period, the problem-event criterion, or the event-count criterion when the endpoint is installed.

4. The method of claim 1 further comprising the step of resetting the number of saved occurrences to zero if two consecutive determinations of utility consumption do not meet the problem-event criterion.

5. The method of claim 1, further comprising the step of transmitting to an AMR system at predetermined intervals, wherein the step of indicating a positive detection further comprises transmitting the indication of positive detection to an AMR system at a predetermined transmission interval.

6. The method of claim 1, further comprising the step of transmitting to an AMR system at predetermined intervals, wherein the step of indicating a positive detection further comprises transmitting the indication of positive detection to an AMR system before a predetermined transmission interval.

7. The method of claim 1, further including the step of configuring a problem-event criterion to an unusually low consumption value.

8. The method of claim 1, further including the step of configuring a problem-event criterion to an unusually high consumption value.

9. The method of claim 1, wherein the saving in memory of the results of the determined utility consumption includes saving an actual consumption value.

10. The method of claim 1, wherein the saving in memory of the results of the determined utility consumption does not include saving an actual consumption value.

11. The method of claim 1, further comprising the step of pausing for a time interval between steps (e) and (f).

12. The method of claim 11, wherein the time interval comprises a sample period.

13. An endpoint communicatively coupled to a utility meter for detecting unusual measurements by the utility meter, the endpoint comprising:
(a) an RF transmitter;
(b) a microprocessor with memory, the microprocessor operated by program instructions including configurable parameters, the parameters including a sampling window, a sampling period, a problem-event criterion, and an event-count criterion;
wherein the endpoint takes and stores in memory a first reading from the utility meter at a start of the sampling window, takes a second reading from the utility meter at an end of the sampling window, and determines a utility consumption during the sampling window from the first and second readings;
wherein the endpoint compares the determined utility consumption to the problem-event criterion and, in response, saves in memory the determined utility consumption as an occurrence if the determined utility consumption meets the problem-event criterion;
wherein the endpoint compares to the event-count criterion a number of consecutive times the determined utility consumption has met the problem-event criterion; and
wherein the RF transmitter transmits an indication of a positive detection if the number of consecutive times the determined utility consumption has met the problem-event criterion equals or exceeds the event-count criterion.

14. The device of claim 13, wherein at least one of the parameters is configurable by the endpoint using self-learning software.

15. The device of claim 13, wherein at least one of the parameters is configurable when the endpoint is installed.

16. The device of claim 13, wherein the number of saved occurrences is reset to zero if two consecutive determinations of utility consumption do not meet the problem-event criterion.

17. The device of claim 13, wherein the RF transmitter transmits to an AMR system at predetermined intervals and transmits the positive detection to the AMR system at a predetermined transmission interval.

18. The device of claim 13, wherein the RF transmitter transmits to an AMR system at a series of predetermined intervals and transmits the positive detection to the AMR system before a predetermined transmission interval.

19. The device of claim 13, wherein the problem-event criterion is an unusually low consumption value.

20. The device of claim 13, wherein the problem-event criterion is an usually high consumption value.

21. The device of claim 13, wherein the saving in memory of the results of the determined utility consumption includes saving an actual consumption value.

22. The device of claim 13, wherein the saving in memory of the results of the determined utility consumption does not include saving an actual consumption value.
